(19) United States
(12) Patent Application Publication
(10) Pub. No.: US 2011/0057414 A1
(43) Pub. Date: Mar. 10, 2011

(54) Bike frame 143

(76) Inventor: Robert V. West, San Antonio, TX (US)

(21) Appl. No.: 12/584,500

(22) Filed: Sep. 8, 2009

(51) Int. Cl. B62K 19/18

(52) U.S. Cl. 280/287

(57) ABSTRACT

This disclosure relates to the design and the fabrication of various bicycle frames. Currently the majority of frames are welded from hollow metals tubes to form a rigid triangular skeleton. The concern for frame integrity has made this design the industry standard for over a century. The current design incorporates a novel array of 4 coupling devices into the 2 main suspension tubes of the bike frame, the Top tube and Down tube. The result of the current design is a frame manufactured with the 4 joints in the suspension tubes so that it can be disassembled into the 3 functional units of the bicycle. Upon reassembly, this feature allows for the substitution of tubes of different length and composition between these joints. As a result, the present design allows for greater variability in the fitting, sizing, and performance options of the bicycle frame to meet the desires of the rider. Furthermore, when disassembled, the Bike Frame 143 allows for more compact storage and transport than is possible with current designs.

### BACKGROUND OF THE INVENTION

The present invention employs a new design and manufacture of the bicycle frame. The 143 Design allows the bicycle frame to be assembled and dissembled into its 3 functional units, thus providing more variation in frame geometry, performance, and portability. The current international energy, economic, and environmental realities are inducing people to ride bikes to a wider variety of places, which entails moving and storing bikes in more compact spaces. However, most current bicycle frame designs are pre-set, rigid, and do not adjust to spatial limitations. Furthermore, once fabricated as a rigid piece, the configuration and composition of these tubes determines the fit and comfort of the frame, forever.

The classic bicycle frame construction utilizes standard cylindrical steel tubes which are connected with lugs. Lugs are fittings made of thicker pieces of steel. The tubes are fitted into the lugs, which encircle the end of the tube, and are then brazed to the lug. The tubes are fitted into the lugs, which encircle the end of the tube, and are then brazed to the lug. Historically, the lower temperatures associated with brazing (silver brazing in particular) had less of a negative impact on the tubing strength than high temperature welding, allowing relatively light tube to be used without loss of strength. Recent advances in metallurgy (“air hardening”) have created tubing that is not adversely affected, or whose properties are even improved by high temperature welding temperatures, which has allowed both Tungsten Inert Gas (TIG) to replace lugged construction. Furthermore alternative materials such as titanium and carbon fiber tubing give frame builders and riders new options in terms of frame perforamance. While steel tubing is still used is still construction, newer more progressive frames can be made from aluminum alloys, titanium, carbon fiber, and even bamboo tubes. These advances give frame builders and riders new options in terms of weight and frame performance of the frame. The stiffer the tubes the harder the ride and vice versa. Nevertheless, the majority of these bicycle frames are manufactured such that the tubes are fused together permanently by either welding or bonding the respective tubes together. These tubes are permanently fabricated into a rigid geometric frame. However, these new improvements in both metallurgy, composition of the tubular components, and TIG welding allow the ends of the major tubes to be fixed at the angles of the frame without lugs.

These advances provide the foundation to allow the fabrication and insertion of dual couplers within the 2 major suspension tubes of the bike frame, the Down tube and Top tube. These couplers can be inserted at the distal ends as shown in FIGS. 1 and 2, or can be more proximate to the center , depending on the desired perfomance, size, and geometry of the bike frame. The 143 Design allows the bicycle frame to be assembled and dissembled into its 3 functional units as the result of 4 couplers fabricated into the 2 main suspension tubes of the bike frame. The central diamond or the main triangle is defined by the four major tubular components of the frame: a.) Steer tube, b) Top tube c.) Down tube, and d) Seat tube. See FIG. 1 and FIG. 2.. The tubular frame once assembled serves as the support structure for the working components of the complete bicycle. See FIG. 1. The tube dimensions of the Main triangle determine the size and geometry of the frame. In addition, the Down and Top tubes serve as the suspension “bridge” between the steering tube and the power train. Hence variations in the length and composition of the tubing inserted between the couplers affects not only the size, but the performance of the frame. Stiff tubes provide a hard ride and vice versa. The power train or rear triangle consists of the Seat tube, and paired chain stays and seat stays, and functions as the power train of the bike. The Steer tube houses and connects the steering apparatus to the bike frame.

More specifically, the current design incorporates a series of couplers in the top tube and down tube to create the four joints, at J1, J2, J3, and J4. A “coupler” is a generic term referring to a mechanical device that can be inserted into a longitudinal array of tubes to allow the ends to be fitted or spliced into one continuous section. The location of these couplers can be spaced so as to be at the distal end of the Top and Down tubes, as depicted in the attached drawings. The tubular frame segment between couplers J1 and J2 corresponds to the detachable Top tube segment (b.), whereas the section between J3 and J4 corresponds to the detachable Down Tube segment. Similarly these couplers may be located distally or more proximate to each along the respective tube length to accommodate a longer or shorter insert depending on the spatial, composition, and performance demands of the designer and cyclist. See FIG. 2.

These joints or couplers when inserted into the tubular frame of the bicycle's Down and Top tube can be disconnected to allow for the assembly and disassembly of the 3 functional frame components. The 3 functional components of the frame are the drive train, the suspension tubes (Top and Down tube segments), and the steering mechanism. Furthermore, the 143 Design allows the rigid frame of the bicycle to be modified to fit the needs of the riders. In the current design, the 143 characteristics permit the insertion of various Top tubes and Down tubes of different lengths and composition between the respective joints. These options thus permit alterations of the size, weight, geometry and ultimately the performance of the bike frame, when these units are reassembled after substitution of the various proposed suspension tube segments.

Furthermore, when disassembled, Bicycle 143 allows for a dramatic reduction in the dimensions of the bicycle frame, allowing for more efficient storage and transport of the bicycle.

### BRIEF DESCRIPTION OF DRAWINGS

Bicycle 143 incorporates 4 coupling devices, “▭”, to create four joints in the central triangle of the bike frame. The couplers depicted at the distal ends of the top and down tube, can be relocated on these tubes in a more proximate location as desired by the fabricator. There are 2 couplers in the Top tube and 2 couplers in the Down tube. These joints allow the central bicycle frame, main triangle, to be broken down into its 3 functional components by disconnecting he top Tube and down tube at points J1, J2, J3, and J4. The main triangle of a Bike 143 with the couplers inserted is depicted in FIG. 1. These functional components when assembled form one complete bicycle.

FIG. 2 depicts a completed utilizing the Bike Frame 143 design.

### DESCRIPTION OF INVENTION

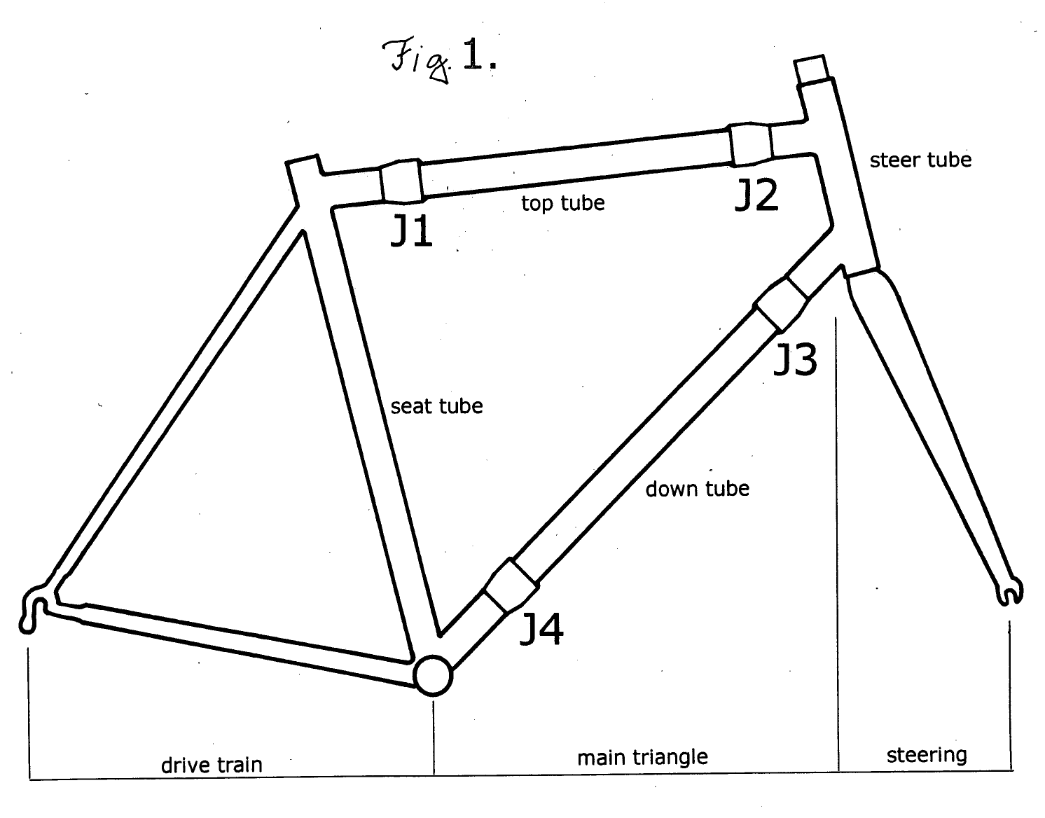

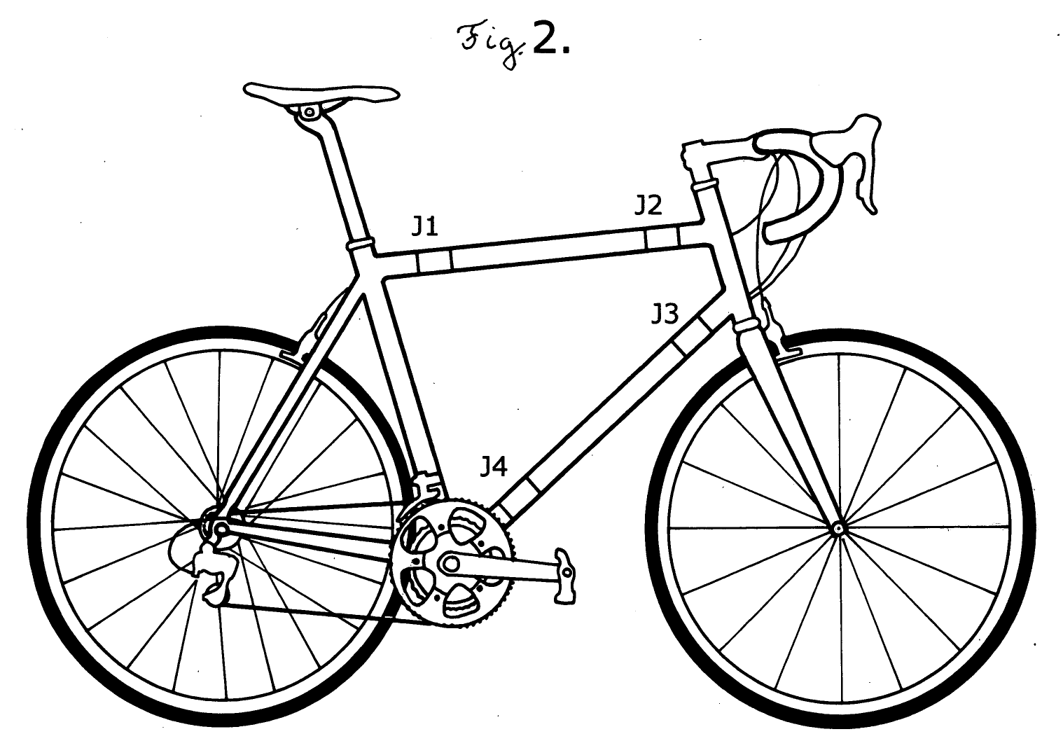

The current design incorporates a series of couplers in the Top tube and Down tube to create the four joints, at J1, J2, J3, and J4. A “coupler” is a generic term referring to a mechanical device that can be inserted into a longitudinal array of tubes to allow the ends to be fitted or spliced into one continuous section. The tubular frame segment between couplers J1 and J2 corresponds to the detachable “Top tube segment”, whereas the section between J3 and J4 corresponds to the detachable “Down tube segment”. The location of these couplers can be spaced so as to be at the distal end of the Top and Down tubes, as depicted in the attached drawings, FIGS. 1 and 2. Similarly these couplers may be located more proximate to each other along the tube's length so as to accommodate a shorter insert depending on the spatial, composition, and performance demands of the designer and cyclist.

FIG. 1. depicts a complete bicycle, showing the relation of the frame and the functional units and components of the bicycle. The 4 joints are locked forming one integral bicycle frame unit.

FIG. 2. depicts just the tubular frame of the bicycle, showing the relations between the frame geometry and the particular configuration of the Bike Frame 143 and its characteristic array of joints. There are 2 couplers in the Top tube and 2 couplers in the Down tube. These joints allow the central bicycle frame to be broken down into its 3 functional units by disconnecting the Top tube and Down tube at points J1, J2, J3, and J4. The 3 functional units of the frame are the drive train, the suspension tubes (“Top and Down tube segments”) , and the steering mechanism.

Accordingly, the 143 Design permits the rigid frame of the bicycle to be modified to fit the needs of the individual rider. The Bike Frame 143 Design characteristics permit the insertion of Top tubes and Down tube segments of various lengths and composition between the 4 respective joints. Once these units are reassembled after various substitutions, these options permit alterations of the size, weight, geometry and ultimately the performance of the bike frame. Furthermore, when disassembled, the Bike Frame 143 allows for more compact storage and transport than is possible with current designs.

### SUMMARY OF INVENTION

Bicycle 143 incorporates coupling devices at four joints to allow the main triangle of the bicycle frame to be broken down from its triangular configuration, at points J1, J2, J3, and J4, into 1.) two suspension tubular segments (the Top tube and Down tube), 2.) the steering mechanism, and 3.) the drive train. In the alternative these individual components can be reassembled to form one complete bicycle frame. These features facilitate the adjustment of the frame size, geometry, composition, and performance by allowing substitution of various tubular components for the Top and Down tube segments. Furthermore, when disassembled, Bicycle 143 allows for the reduction in the dimensions of the bicycle, allowing for more efficient storage and transport of the bicycle.

My claims are:

1. A bicycle frame with 4 joints created by the insertion of couplers into the top tube and down tube of the major triangle of the frame, which allows for splicing of tubes of various composition, length, and geometry into the suspension tubes of the main triangle of the bike frame.)

2. A bicycle frame with a detachable and interchangeable Top and Down tube segments.

3. A bicycle frame which contains 4 joints which allows the frame to be broken down into its 3 functional units, i.) the steering mechanism, ii.) the drive train, and iii.) the 2 suspension tubes (Top and Down), then reassembled into one functional bicycle unit.
